(19) United States
(12) Patent Application Publication
(10) Pub. No.: US 2025/0329070 A1
(43) Pub. Date: Oct. 23, 2025

(54) DATA-DRIVEN SYSTEM AND METHOD TO ACCESS AND CORRECT SYSTEM RESPONSES

(71) Applicant: GE Precision Healthcare LLC, Waukesha, WI (US)

(72) Inventors: Kuan-Hao Su, Brookfield, WI (US); Moshe Levy, Zikhron Yakov (IL); Floribertus Philippus Martinus Heukensfeldt Jansen, Ballston Lake, NY (US)

(21) Appl. No.: 18/641,701

(22) Filed: Apr. 22, 2024

(51) Int. Cl. G06T 11/00; G06T 7/00; G06T 7/73

(52) U.S. Cl. CPC G06T 11/008; G06T 7/0012; G06T 7/74; G06T 11/006; G06T 2207/10104; G06T 2207/20081; G06T 2207/30096; G06T 2207/30196; G06T 2210/41; G06T 2211/441

(57) ABSTRACT

A method includes obtaining raw scan data from a clinical scan of a subject with a medical imaging system. The method includes inserting synthetic raw scan data with one or more known lesion values into the raw scan data to generate modified raw scan data. The method includes separately reconstructing the raw scan data and the modified raw scan data to respectively generate a first reconstructed image and a second reconstructed image. The method includes extracting information from the first reconstructed image and the second reconstructed image. The method includes determining a system response to the inserted synthetic raw data based on the extracted information and one or more target lesion values, and wherein the system response is specific to the medical imaging system and a reconstruction technique utilized by the medical imaging system. The method includes utilizing the system response to correct the raw scan data.

### BACKGROUND

The subject matter disclosed herein relates to medical imaging and, more particularly, to a system and method for data-driven system and method to access and correct system responses.

Diagnostic imaging technologies allow images of internal features of a patient to be non-invasively obtained and may provide information about the function and integrity of the patient's internal structures. Diagnostic imaging systems may operate based on various physical principles, including the positron emission or transmission of radiation from the patient tissues. For example, positron emission tomography (PET) may utilize a radiopharmaceutical that is administered to a patient and whose breakdown results in the positron emission of gamma rays from locations within the patient's body. The radiopharmaceutical is typically selected so as to be preferentially or differentially distributed in the body based on the physiological or biochemical processes in the body. For example, a radiopharmaceutical may be selected that is preferentially processed or taken up by tumor tissue. In such an example, the radiopharmaceutical will typically be disposed in greater concentrations around tumor tissue within the patient.

In the context of PET imaging, the radiopharmaceutical typically breaks down or decays within the patient, releasing a positron which annihilates when encountering an electron and produces a pair of gamma rays moving in opposite directions. These gamma rays interact with detection mechanisms within the PET scanner, which allow the decay events to be localized, thereby providing a view of where the radiopharmaceutical is distributed throughout the patient. In this manner, a caregiver can visualize where in the patient the radiopharmaceutical is disproportionately distributed and may thereby identify where physiological structures and/or biochemical processes of diagnostic significance are located within the patient.

A PET imaging system generates images that represent the distribution of positron-emitting nuclides within the body of a patient. When a positron interacts with an electron by annihilation, the entire mass of the positron-electron pair is converted into two 511 keV photons. The photons are emitted in opposite directions along a line of response. The two annihilation photons (known as a coincidence pair) can be detected by detectors that are placed along the line of response on a detector ring. When these photons arrive and are detected at the detector elements at the same or nearly the same time, this is referred to as coincidence or coincidence event (COIN). An image is then generated, based on the acquired data that includes the annihilation photon detection information.

There are a number of parameters that can affect the final clinical images. For this reason, data processed under different conditions can result in different lesion recovery values. This makes the comparison among different acquisition and reconstruction techniques extremely difficult. For example, patient dose, patient condition, acquisition system, reconstruction parameters, and/or post-processing techniques can be quite different in each scan. As each condition results in lesion values, it is not feasible for comparing results collected and processed under different conditions.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a computer-implemented method for accessing and correcting system responses is provided. The computer-implemented method includes obtaining, at a processor, raw scan data from a clinical scan of a subject with a medical imaging system. The computer-implemented method also includes inserting, via the processor, synthetic raw scan data with one or more known lesion values into the raw scan data to generate modified raw scan data. The computer-implemented method further includes separately reconstructing, via the processor, the raw scan data and the modified raw scan data to respectively generate a first reconstructed image and a second reconstructed image. The computer-implemented method even further includes extracting, via the processor, information from the first reconstructed image and the second reconstructed image. The computer-implemented method yet further includes determining, via the processor, a system response to the inserted synthetic raw data based on the information extracted from the first reconstructed image and the second reconstructed image and one or more target lesion values, and wherein the system response is specific to the medical imaging system and a reconstruction technique utilized by the medical imaging system. The computer-implemented method still further includes utilizing, via the processor, the system response to correct the raw scan data.

In another embodiment, a system for accessing and correcting system responses is provided. The system includes a memory encoding processor-executable routines. The system also includes a processing system including one or more processors and configured to access the memory and to execute the processor-executable routines, wherein the processor-executable routines, when executed by the processing system, cause the processing system to perform actions. The actions include obtaining raw scan data from a clinical scan of a subject with a medical imaging system. The actions also include inserting synthetic raw scan data with one or more known lesion values into the raw scan data to generate modified raw scan data. The actions further include separately reconstructing the raw scan data and the modified raw scan data to respectively generate a first reconstructed image and a second reconstructed image. The actions even further include extracting information from the first reconstructed image and the second reconstructed image. The actions yet further include determining a system response to the inserted synthetic raw data based on the information extracted from the first reconstructed image and the second reconstructed image and one or more target lesion values, and wherein the system response is specific to the medical imaging system and a reconstruction technique utilized by the medical imaging system. The actions still further include utilizing the system response to correct the raw scan data.

In a further embodiment, a non-transitory computer-readable medium is provided. The non-transitory computer-readable medium includes processor-executable code that when executed by a processing system including one or more processors, causes the processing system to perform actions. The actions include obtaining raw scan data from a clinical scan of a subject with a medical imaging system. The actions also include inserting synthetic raw scan data with one or more known lesion values into the raw scan data to generate modified raw scan data. The actions further include separately reconstructing the raw scan data and the modified raw scan data to respectively generate a first reconstructed image and a second reconstructed image. The actions even further include extracting information from the first reconstructed image and the second reconstructed image. The actions yet further include determining a system response to the inserted synthetic raw data based on the information extracted from the first reconstructed image and the second reconstructed image and one or more target lesion values, and wherein the system response is specific to the medical imaging system and a reconstruction technique utilized by the medical imaging system. The actions still further include utilizing the system response to correct the raw scan data.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of an embodiment of a positron emission tomography imaging system, in accordance with aspects of the present disclosure;

FIG. 2 is a schematic diagram of an embodiment of a 3-D PET scanner, in accordance with aspects of the present disclosure;

FIGS. 3A, 3B, 3C, and 3D are schematic diagrams of perspective view, a trans-axial view, a side view, and another side view illustrating a ring difference, respectively, of a portion of a 3D PET scanner illustrating a line of response (LOR) in a PET imaging system, in accordance with aspects of the present disclosure;

FIG. 4 is a schematic diagram illustrating a process for accessing and correcting system responses, in accordance with aspects of the present disclosure;

FIG. 5 is a schematic diagram illustrating input features utilized in generating a model, in accordance with aspects of the present disclosure;

FIG. 6 is a schematic diagram comparing the determination of a true value for a target value for different reconstruction techniques, in accordance with aspects of the present disclosure;

FIG. 7 is a flow diagram of a method for accessing and correcting system responses, in accordance with aspects of the present disclosure;

FIG. 8 is a flow diagram of a method for generating data for generation of a model, in accordance with aspects of the present disclosure;

FIG. 9 is a flow diagram of a method for generating a system model for correcting system responses, in accordance with aspects of the present disclosure;

FIG. 10 is a flow diagram of a method for generating a result utilizing the system model, in accordance with aspects of the present disclosure;

FIG. 11 is a graph (e.g., scattered plot) and a zoomed portion of the graph illustrating a 10-fold cross-validation for original and corrected activities, in accordance with aspects of the present disclosure; and

FIG. 12 is a graph (e.g., bar graph) illustrating a comparison of original and corrected standardized uptake values (e.g., on data acquired from a phantom) relative to the true standardized uptake value, in accordance with aspects of the present disclosure; and

FIG. 13 depicts a PET image of a phantom with circles representing locations where different sized spheres are inserted into the original data.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Furthermore, the term processor or processing unit, as used herein, refers to any type of processing unit or system that can carry out the required calculations needed for the various embodiments, such as single or multi-core: CPU, Accelerated Processing Unit (APU), Graphics Board, DSP, FPGA, ASIC, cloud-based system, or a combination thereof, or a plurality of separate processing units. In addition, parts of the methods described below may be executed on different processors.

The present disclosure provides systems and methods for data-driven system response correction. In particular, the described systems and methods access system responses by inserting known data into original data and then use an estimated system response to perform data correction. The disclosed systems and methods include recovering a true (i.e., actual) value (e.g., true lesion value) based on the data-driven system responses. In this case, results from different conditions (e.g., data collected by different scanners and/or processing techniques) can be comparable as the true value is revealed after the correction. The disclosed systems and methods improve quantification accuracy. For example, the disclosed systems and methods can be utilized to generate harmonized standardized uptake values that match EANM Research Ltd. (EARL) criteria. With the disclosed systems and methods a comparison of longitudinal scan from patients under theranostic treatments can become more robust. In addition, although discussed in the context of PET imaging, the disclosed technique can be utilized for all kinds of data in which system response can be estimated by inserting known data. Also, the technique may be utilized to solve the issue of unknown quantification biases of images with different processing techniques such as block sequential regularized Bayesian penalized-likelihood reconstruction of PET data with different betas (i.e., penalization factors, time-of-flight ordered-subset expectation maximization reconstruction of PET data with different post filtering, and deep learning-based reconstruction of PET data with different models.

The disclosed systems and methods include obtaining raw scan data from a clinical scan of a subject with a medical imaging system. The disclosed systems and methods also include inserting synthetic raw scan data with one or more known lesion values into the raw scan data to generate modified raw scan data. The disclosed systems and methods further include separately reconstructing the raw scan data and the modified raw scan data to respectively generate a first reconstructed image and a second reconstructed image. The disclosed systems and methods even further include extracting information (e.g., input features) from the first reconstructed image and the second reconstructed image. The disclosed systems and methods yet further include determining a system response to the inserted synthetic raw data based on the information extracted from the first reconstructed image and the second reconstructed image and one or more target lesion values, and wherein the system response is specific to the medical imaging system and a reconstruction technique utilized by the medical imaging system. The disclosed systems and methods still further include utilizing the system response to correct the raw scan data.

In certain embodiments, the synthetic raw scan data is derived from the raw scan data. In certain embodiments, the disclosed systems and methods include generating images with synthetic lesions based on the raw scan data, performing forward projection on the images to generate the synthetic raw scan data, applying corrections on the synthetic raw scan data, and performing Poisson noise realization on the synthetic raw scan data to add noise to the synthetic raw scan data prior to insertion into the raw scan data.

In certain embodiments, the disclosed systems and methods include receiving input of the one or more target lesion values. In certain embodiments, determining the system response includes performing fitting and establishing a conversion model between the information extracted (e.g., input features) from the first reconstructed image and the second reconstructed image and the one or more target lesion values. In certain embodiments, the disclosed systems and methods include defining within the first reconstructed image a location with a clinical feature, extracting data information associated with the clinical feature, and estimating a respective actual value for the one or more target lesion values for the clinical feature utilizing the conversion model to correct the raw scan data associated with the clinical feature. In certain embodiments, the medical imaging system is a positron emission tomography imaging system and the one or more target lesion values include standardized uptake value. In certain embodiments, the one or more target lesion values include actual activity value and/or actual feature size. In certain embodiments, the information (e.g., input features) extracted from the first reconstructed image and the second reconstructed image includes image derived values and reconstruction derived values. In certain embodiments, the image derived values include one or more of background activity mean and standard deviation, background activity max, feature activity mean, and feature activity max, and the reconstruction derived values include one or more of a beta map and a kappa map.

The disclosed embodiments also provide a non-transitory computer-readable medium The non-transitory computer-readable medium includes processor-executable code that when executed by a processing system including one or more processors, causes the processing system to perform actions. The actions include obtaining raw scan data from a clinical scan of a subject with a medical imaging system. The actions also include inserting synthetic raw scan data with one or more known lesion values into the raw scan data to generate modified raw scan data. The actions further include separately reconstructing the raw scan data and the modified raw scan data to respectively generate a first reconstructed image and a second reconstructed image. The actions even further include extracting information from the first reconstructed image and the second reconstructed image. The actions yet further include determining a system response to the inserted synthetic raw data based on the information extracted from the first reconstructed image and the second reconstructed image and one or more target lesion values, and wherein the system response is specific to the medical imaging system and a reconstruction technique utilized by the medical imaging system. The actions still further include utilizing the system response to correct the raw scan data.

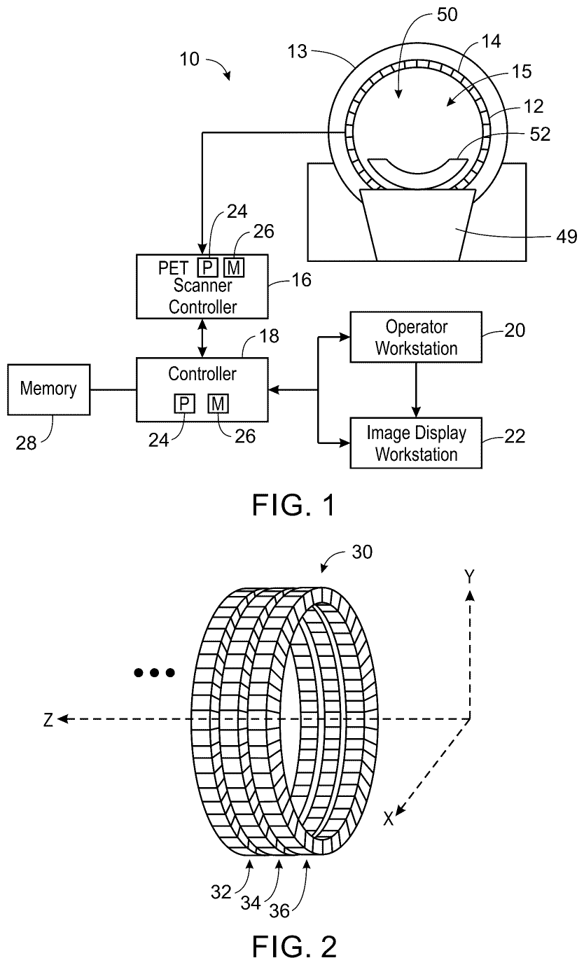

With the foregoing in mind and turning now to the drawings, FIG. 1 depicts a PET imaging system 10 operating in accordance with certain aspects of the present disclosure. The PET imaging system of FIG. 1 may be utilized with a dual-modality imaging system such as a PET-CT imaging system.

Returning now to FIG. 1, the depicted PET imaging system 10 includes a detector array 12. The detector array 12 of the PET imaging system 10 typically includes a number of detector modules or detector assemblies (generally designated by reference numeral 14) arranged in a plurality of rings as depicted in FIG. 1. Each detector module 14 may include a scintillator block (e.g., having a plurality of scintillation crystals) and a photomultiplier tube (PMT) or other light sensor or photosensor (e.g. silicon avalanche photodiode, solid state photomultiplier, etc.). In certain embodiments, a respective photosensor is associated with a respective scintillator crystal. In some embodiments, direct conversion, solid-state photon detectors can be used. The PET imaging system 10 includes a gantry 13 that is configured to support a full ring annular detector array 12 thereon. The detector array 12 is positioned around the central opening/bore 50 and can be controlled to perform a normal “emission scan” in which positron annihilation events are counted. To this end, the detector modules 14 forming the detector array 12 generally generate intensity output signals corresponding to each annihilation photon (which are acquired by acquisition circuitry coupled to the detector modules 14).

The depicted PET system 10 also includes a PET scanner controller 16, a controller 18, an operator workstation 20, and an image display workstation 22 (e.g., for displaying an image). In certain embodiments, the PET scanner controller 16, controller 18, operator workstation 20, and image display workstation 22 may be combined into a single unit or device or fewer units or devices. The PET system 10 also includes a table 52 coupled to a table base 49. The table 52 is configured to be moved into and out of the opening/bore 50 with the patient on the table 52.

The PET scanner controller 16, which is coupled to the detector 12, may be coupled to the controller 18 to enable the controller 18 to control operation of the PET scanner controller 16. Alternatively, the PET scanner controller 16 may be coupled to the operator workstation 20 which controls the operation of the PET scanner controller 16. In operation, the controller 18 and/or the workstation 20 controls the real-time operation of the PET system 10. One or more of the PET scanner controller 16, the controller 18, and/or the operation workstation 20 may include a processor 24 and/or memory 26. In certain embodiments, the PET system 10 may include a separate memory 28. The detector 12, PET scanner controller 16, the controller 18, and/or the operation workstation 20 may include detector acquisition circuitry for acquiring image data from the detector 12 and image reconstruction and processing circuitry for image processing. The circuitry may include specially programmed hardware, memory, and/or processors.

The processor 24 may include multiple microprocessors, one or more “general-purpose” microprocessors, one or more special-purpose microprocessors, and/or one or more application specific integrated circuits (ASICS), system-on-chip (SoC) device, or some other processor configuration. For example, the processor 24 may include one or more reduced instruction set (RISC) processors or complex instruction set (CISC) processors. The processor 24 may execute instructions to carry out the operation of the PET system 10. These instructions may be encoded in programs or code stored in a tangible non-transitory computer-readable medium (e.g., an optical disc, solid state device, chip, firmware, etc.) such as the memory 26, 28. In certain embodiments, the memory 26 may be wholly or partially removable from the controller 16, 18.

As described in greater detail below, the processor 24 is configured for data-driven system response correction. In particular, the processor 24 is configured to obtain raw scan data from a clinical scan of a subject with a medical imaging system. The disclosed systems and methods also include inserting synthetic raw scan data with one or more known lesion values into the raw scan data to generate modified raw scan data. The processor 24 is configured to separately reconstruct the raw scan data and the modified raw scan data to respectively generate a first reconstructed image and a second reconstructed image. The processor 24 is configured to extract information (e.g., input features) from the first reconstructed image and the second reconstructed image. The processor 24 is configured to determine a system response to the inserted synthetic raw data based on the information extracted from the first reconstructed image and the second reconstructed image and one or more target lesion values, and wherein the system response is specific to the medical imaging system and a reconstruction technique utilized by the medical imaging system. The processor 24 is configured to utilize the system response to correct the raw scan data.

In certain embodiments, the synthetic raw scan data is derived from the raw scan data. In certain embodiments, the processor 24 is configured to generate images with synthetic lesions based on the raw scan data, performing forward projection on the images to generate the synthetic raw scan data, to apply corrections on the synthetic raw scan data, and to perform Poisson noise realization on the synthetic raw scan data to add noise to the synthetic raw scan data prior to insertion into the raw scan data.

In certain embodiments, the processor 24 is configured to receive input of the one or more target lesion values. In certain embodiments, determining the system response includes performing fitting and establishing a conversion model between the information extracted (e.g., input features) from the first reconstructed image and the second reconstructed image and the one or more target lesion values. In certain embodiments, the processor 24 is configured to define within the first reconstructed image a location with a clinical feature, extracting data information associated with the clinical feature, and to estimate a respective actual value for the one or more target lesion values for the clinical feature utilizing the conversion model to correct the raw scan data associated with the clinical feature. In certain embodiments, the medical imaging system is a positron emission tomography imaging system and the one or more target lesion values include standardized uptake value. In certain embodiments, the one or more target lesion values include actual activity value and/or actual feature size. In certain embodiments, the information (e.g., input features) extracted from the first reconstructed image and the second reconstructed image includes image derived values and reconstruction derived values. In certain embodiments, the image derived values include one or more of background activity mean and standard deviation, background activity max, feature activity mean, and feature activity max, and the reconstruction derived values include one or more of a beta map and a kappa map.

By way of example, PET imaging is primarily used to measure metabolic activities that occur in tissues and organs and, in particular, to localize aberrant metabolic activity. In PET imaging, the patient is typically injected with a solution that contains a radioactive tracer. The solution is distributed and absorbed throughout the body in different degrees, depending on the tracer employed and the functioning of the organs and tissues. For instance, tumors typically process more glucose than a healthy tissue of the same type. Therefore, a glucose solution containing a radioactive tracer may be disproportionately metabolized by a tumor, allowing the tumor to be located and visualized by the radioactive emissions. In particular, the radioactive tracer emits positrons that interact with and annihilate complementary electrons to generate pairs of gamma rays. In each annihilation reaction, two gamma rays traveling in opposite directions are emitted. In a PET imaging system 10, the pair of gamma rays are detected by the detector array 12 configured to ascertain that two gamma rays detected sufficiently close in time are generated by the same annihilation reaction. Due to the nature of the annihilation reaction, the detection of such a pair of gamma rays may be used to determine the line of response along which the gamma rays traveled before impacting the detector, allowing localization of the annihilation event to that line. By detecting a number of such gamma ray pairs, and calculating the corresponding lines traveled by these pairs, the concentration of the radioactive tracer in different parts of the body may be estimated and a tumor, thereby, may be detected. Therefore, accurate detection and localization of the gamma rays forms a fundamental and foremost objective of the PET imaging system 10.

Data associated with coincidence events along a number of LORs may be collected and further processed to reconstruct three-dimensional (3-D) tomographic images. Modern PET scanners, specifically large AFOV scanners, operate in a 3-D PET mode, where coincidence events from different detector rings positioned along the axial direction are counted to obtain tomographic images. For example, a PET scanner 30 with multiple detector rings is shown in FIG. 2, where the individual detectors and photosensors are not shown. The PET scanner detector 30 includes a plurality of detector rings. In FIG. 2 only three detector rings 32, 34 and 36 of the plurality of detector rings are shown. The number of detector rings may vary (e.g., 2, 3, 4, 5, or more detector rings. In a larger AFOV PET detector, the number of detector rings is greater than 10 rings. Most narrow AFOV PET cameras have a sensitivity along their AFOV having the shape of a triangle, while are large AFOV PET scanner (e.g., having greater than 10 detector rings) can have a sensitivity along the AFOV having the shape of a trapezoid. However, some large AFOV PET scanner are having sensitivity along their AFOV having the shape of a triangle. In the disclosed embodiments, coincidence events may occur in different detector rings of different gantry segments of the modular gantry along the axial direction.

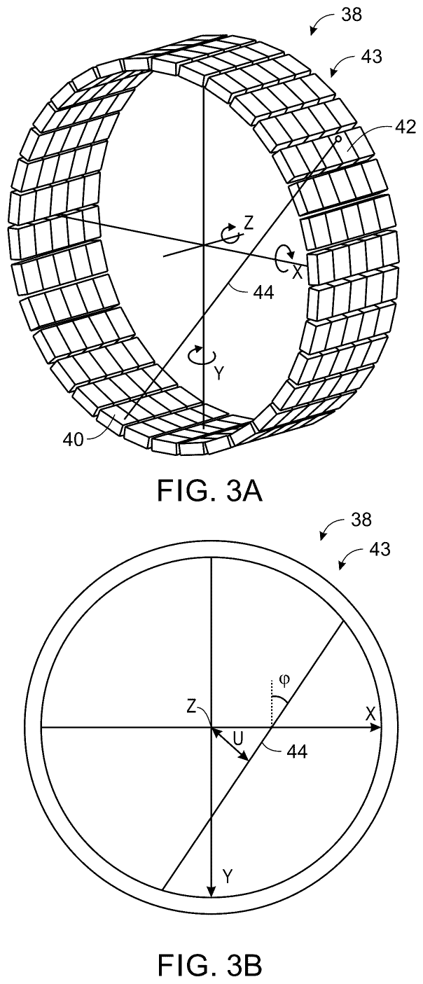

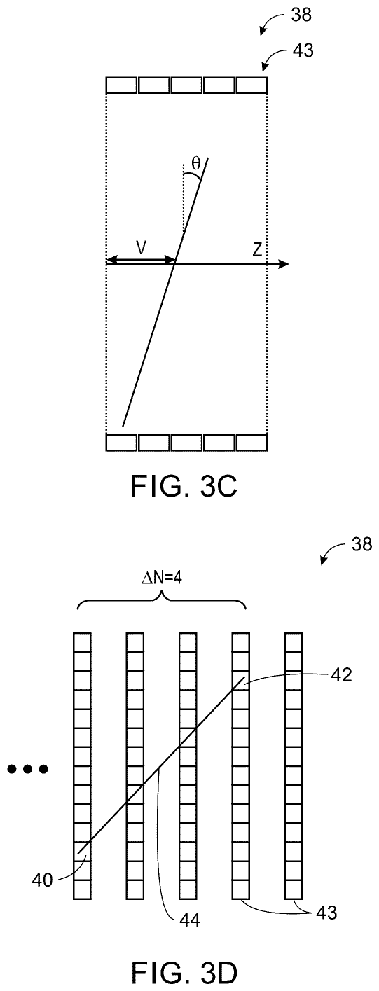

Traditionally, data associated with coincidence events are stored in the form of sinograms based on their corresponding LORs. For example, in a 3-D PET scanner 38 like the one illustrated in FIGS. 3A-D, if a pair of coincidence events are detected by detectors 40 and 42 in different detector rings 43, an LOR may be established as a straight line 44 linking the two detectors 40, 42. It should be noted for simplicity only five rings 53 are shown and only two of the five rings 53 are marked for simplicity. In a 3-D PET scanner, an LOR is defined by four coordinates (u, φ, v, θ), wherein the first coordinate u is the radial distance of the LOR from the center axis of the detector, the second coordinate φ is the trans-axial angle between the LOR and the X-axis, the third coordinate v is the distance of the LOR from the center of the detector rings along the Z-axis, and the fourth coordinate θ is the axial angle between the LOR and the center axis (or Z-axis) of the detector rings. As the PET scanner continues to detect coincidence events along various LORs, these events may be binned and accumulated in their corresponding elements. In this case, the detected coincidence events are stored in a 4-D sinogram (u, φ, v, θ), where each element of which holds an event count for a specific LOR. As illustrated in FIGS. 3C and 3D (which are a side views of a 3-D PET scanner 38 having a plurality of detector rings 43, (only five rings are drawn, and only two of the five are marked to avoid cluttering the drawing), a pair of coincidence events are detected by two detectors 40 and 42 on different detector rings 43, an LOR may be established as a straight line 44 linking the two detectors 40 and 42. As depicted in the example in FIG. 3D, there is a ring difference (ΔN) of 4.

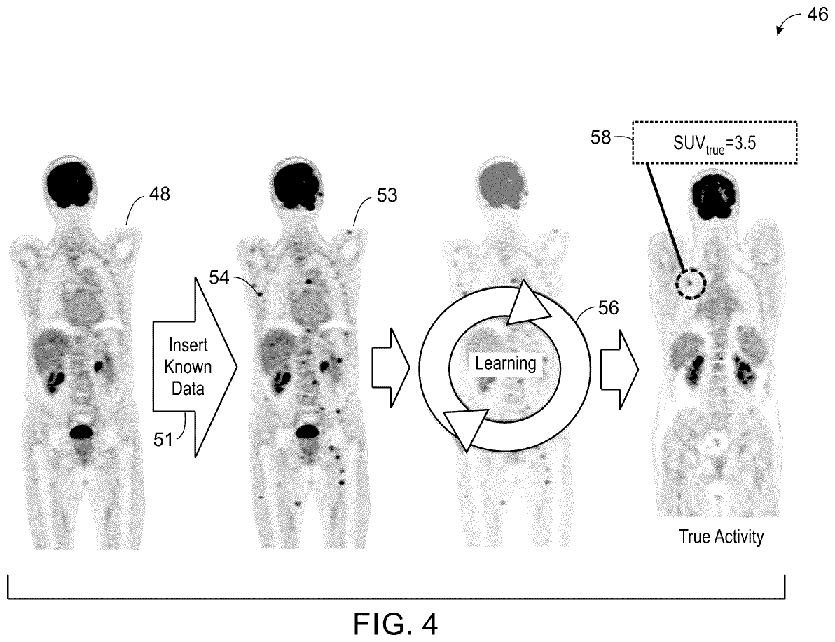

FIG. 4 is a schematic diagram illustrating a process 46 for accessing and correcting system responses (e.g., system biases). System responses to acquiring scan data and reconstructing images from the scan data are specific to the medical imaging system (e.g., scanner) and the reconstruction technique utilized. Previous approaches utilized data collectedly separately (e.g., phantom data) to evaluate the system response and then utilize system response for correction. In contrast, the technique disclosed herein emphasizes putting known information into raw data (e.g., clinical scanned PET data) and utilizing the known data to estimate the system response and then utilize the system response to perform correction. The technique disclosed herein improves quantification accuracy of measured values across different imaging techniques and systems.

The process 46 includes obtaining original data (e.g., scan data such as PET scan data) from a clinical scan (e.g., PET scan) of a subject with a scanner (e.g., PET scanner). The medical imaging system (e.g., PET imaging system) reconstructs the original data utilizing a specific reconstruction technique. A reconstructed image 48 of the original data is depicted in FIG. 4. The scanner and the reconstruction technique have an unknown quantification bias in quantifying a value (e.g., lesion value related to activity and/or feature size) which makes the value inaccurate. The example value in FIG. 4 is standardized uptake value (SUV). The process 46 also includes inserting known data (e.g., synthetic features such as synthetic lesions) into the original data to modify the data as indicated by reference numeral 51. The known has known values such as known lesion values. A targeted processing technique such as a selected reconstruction technique or transformation technique is performed on the modified data. A reconstructed image 53 of the modified data having multiple inserted synthetic features 54 is depicted in FIG. 4. The number, shapes, activity level, and locations of the synthetic features inserted into the original data may vary. In the reconstructed image 53, over 300 synthetic features were inserted.

The process 46 further includes evaluating and estimating (i.e., determining) the system response (e.g., system bias) based on the inserted known data. For example, an artificial intelligence engine (e.g., machine learning engine), as indicated by reference numeral 56, may be utilized to generate a model (e.g., conversion model) that is configured to correct a measured value to account for the system response to determine the true, actual, or real value (i.e., corrected value) that should be obtained across different scanners and reconstruction techniques as there is only one true value. The conversion model is specific to the dataset. The model may consist of a multi-variant algorithm. In certain embodiments, may utilize high dimensional correction curves specific to the dataset. Information (e.g., input features) extracted from the reconstruction of the original data and the modified data may be utilized in generating the model. For example, image derived values and/or reconstruction derived values. In addition, one or more target values (e.g., as selected by a user) may be inputted and utilized in generating the model. The target values (e.g., target lesion values) may include actual activity value and/or actual feature size. In certain embodiments, the actual activity value meets EARL criteria. The process 46 even further includes applying the system response (e.g., the model) to correct the original data. In certain embodiments, the results may be converted into systems with known results. Reference numeral 58 depicts the true value (e.g., true activity value such as true standardized uptake value) of the target lesion value obtained by correcting the measured value for a clinical feature (e.g., selected manually or automatically) in the original data.

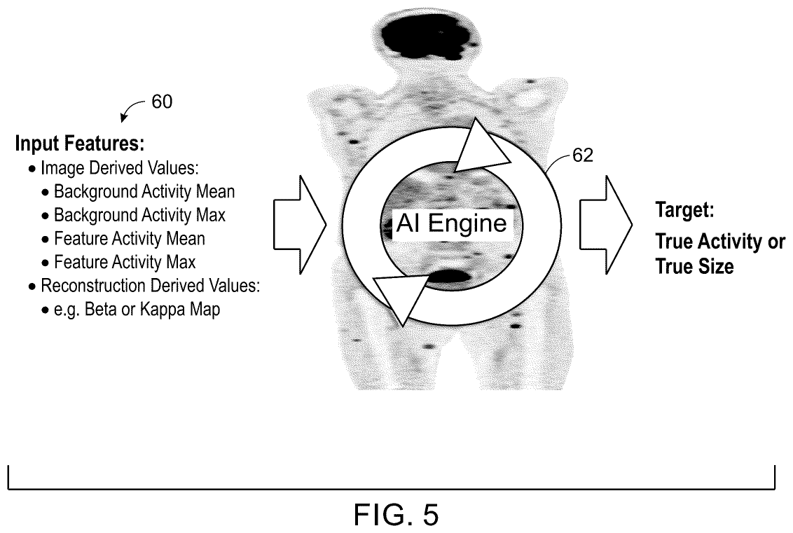

FIG. 5 is a schematic diagram illustrating input features 60 utilized in generating a model (e.g., for determining a true value for a target value (e.g., activity)). As depicted, the input features 60 are inputted into an artificial intelligence (AI) engine 62 to generate the model. As depicted, the input features 60 include image derived features such as background activity mean, background activity max, feature activity mean, and/or feature activity max. The input features 60 also include reconstruction derived values such as beta or kappa maps.

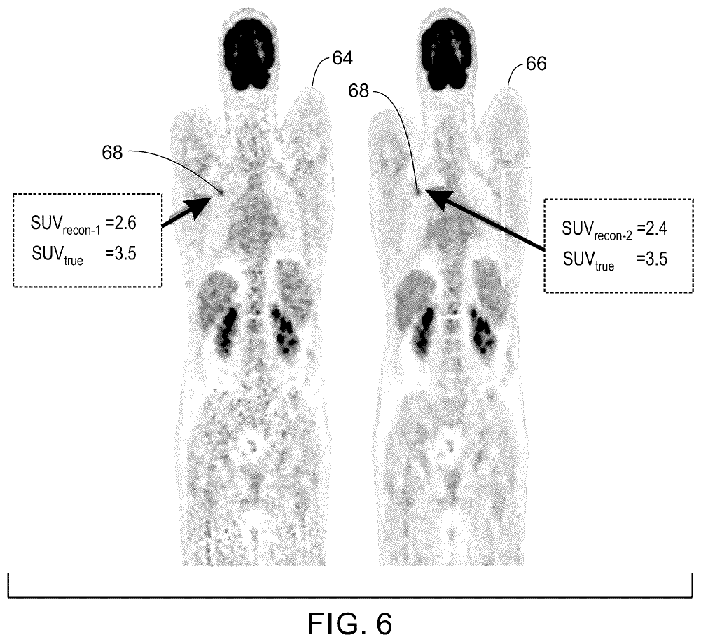

FIG. 6 is a schematic diagram comparing the determination of a true value for a target value for different reconstruction techniques utilizing the technique described herein. The left side of FIG. 6 depicts a PET image 64 reconstructed from PET scan data acquired with a scanner, where the image 64 is reconstructed utilizing a first reconstruction technique (recon-1). The right side of FIG. 6 depicts a PET image 66 reconstructed from same PET scan data, where the image 66 is reconstructed utilizing a second reconstruction technique (recon-2) different from the first reconstruction technique. As depicted, the measured standardized uptake value (SUV_{recon-1}) obtained for a selected clinical feature 68 utilizing the first reconstruction technique is different from the measured standardized uptake value (SUV_{recon-2}) obtained for the same selected clinical feature 68 utilizing the second reconstruction technique. However, the true standardized uptake value (SUV true) obtained utilizing the disclosed technique (i.e., estimating the true value (correcting the measured values) based on the system response to the inserted data) is the same. As mentioned above, only one true value exists across different scanners and reconstruction techniques.

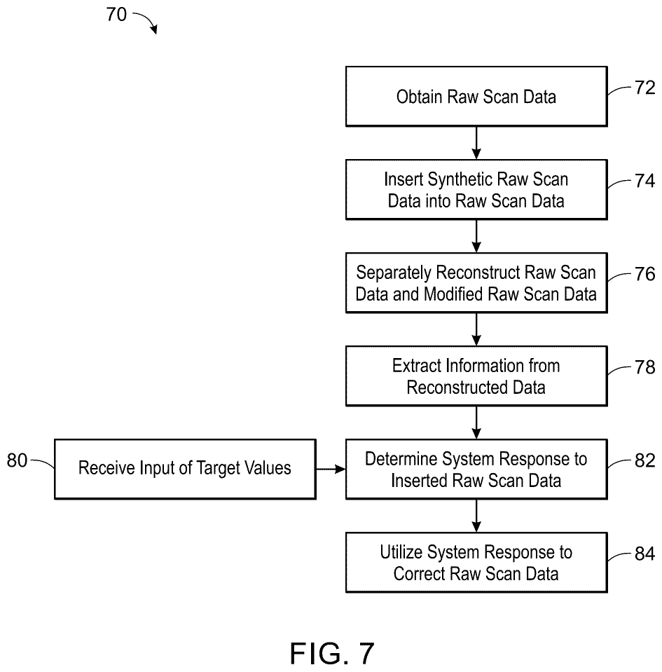

FIG. 7 is a flow diagram of a method 70 for accessing and correcting system responses. One or more steps of the method 70 may be performed by processing circuitry of an imaging system (e.g., PET imaging system 10 in FIG. 1) or a remote computing device. One or more of the steps of the method 70 may be performed simultaneously or in a different order from the order depicted in FIG. 7.

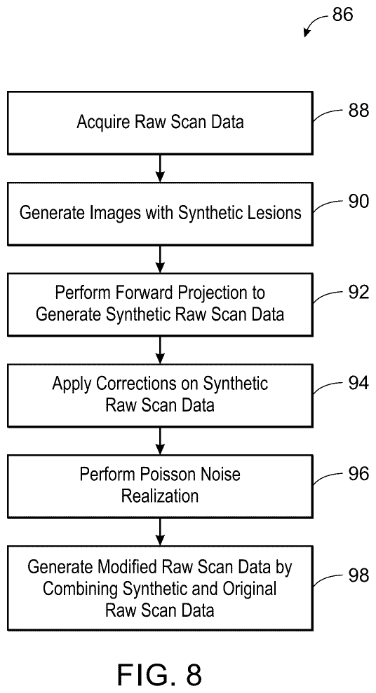

The method 70 includes obtaining raw scan data (e.g., PET scan data) from a clinical scan (e.g., PET scan) of a subject (e.g., patient) with a medical imaging system (e.g., PET imaging system) (block 72). The method 70 also includes inserting synthetic raw scan data (e.g., synthetic PET scan data) with one or more known lesion values (e.g., activity, feature size, etc.) into the raw scan data to generate modified raw scan data (block 74). In certain embodiments, the synthetic raw scan data is derived from the raw scan data as described in the method 86 in FIG. 8. The method 70 further includes separately reconstructing the raw scan data and the modified raw scan data to respectively generate a first reconstructed image and a second reconstructed image (block 76). The method 70 even further includes extracting information from the reconstructed data (i.e., the first reconstructed image and the second reconstructed image) (block 78). In certain embodiments, the information extracted from the first reconstructed image and the second reconstructed image includes image derived values and reconstruction derived values. In certain embodiments, the image derived values include one or more of background activity mean and standard deviation, background activity max, feature activity mean, and feature activity max. In certain embodiments, the reconstruction derived values include one or more of beta map and kappa map.

The method 70 includes receiving input (e.g., user input) of the one or more target lesion values (block 80). In certain embodiments, the one or more target lesion values include actual activity value, actual feature size, or both. The method 70 yet further includes determining a system response (e.g., system bias) to the inserted synthetic raw data based on the information extracted from the first reconstructed image and the second reconstructed image and the one or more target lesion values, and wherein the system response is specific to the medical imaging system and a reconstruction technique utilized by the medical imaging system (block 82). In certain embodiments, determining the system response includes performing fitting and establishing a conversion model between the information extracted from the first reconstructed image and the second reconstructed image and the one or more target lesion values. The method 70 still further includes utilizing the system response to correct the raw scan data (block 84). In certain embodiments, utilizing the system response includes utilizing the model to estimate the one or more lesions values (e.g., actual or true values for the lesions values).

FIG. 8 is a flow diagram of a method 86 for generating data for generation of a model. One or more steps of the method 86 may be performed by processing circuitry of an imaging system (e.g., PET imaging system 10 in FIG. 1) or a remote computing device. One or more of the steps of the method 86 may be performed simultaneously or in a different order from the order depicted in FIG. 8.

The method 86 includes acquiring/obtaining raw scan data (e.g., PET scan data) from a clinical scan (e.g., PET scan) of a subject (e.g., patient) with a medical imaging system (e.g., PET imaging system) (block 88). The method 86 also includes generating images with synthetic lesions (e.g., features) based on the raw scan data (block 90). The features may vary in size, shape, activity, and/or location. The method 86 further includes performing forward projection on the images to generate synthetic raw scan data (e.g., synthetic PET scan data) (block 92). The method 86 includes applying corrections on the synthetic raw scan data (block 94). In certain embodiments, the corrections may include detector geometry and normalization correction, deadtime and pile-up correction, attenuation correction, point-spread-function correction, and/or other types of corrections. The method 86 also includes perform Poisson noise realization on the synthetic raw scan data to add noise to the synthetic raw scan data prior to insertion into the raw scan data (block 96). The method 86 further includes generating modified raw scan data by combining the synthetic raw scan data and the original raw scan data (block 98).

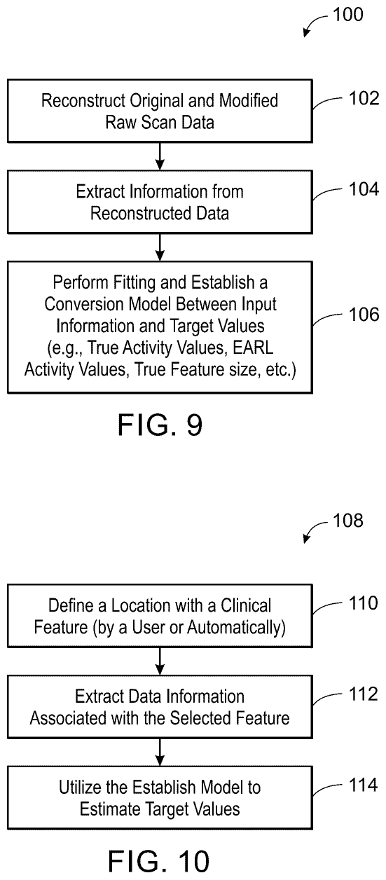

FIG. 9 is a flow diagram of a method 100 for generating a system model for correcting system responses (e.g., system biases). One or more steps of the method 100 may be performed by processing circuitry of an imaging system (e.g., PET imaging system 10 in FIG. 1) or a remote computing device. One or more of the steps of the method 100 may be performed simultaneously or in a different order from the order depicted in FIG. 9.

The method 100 includes separately reconstructing the raw scan data (e.g., original raw scan data) and the modified raw scan data (i.e., raw scan data with inserted synthetic raw scan data) (block 102). Thus, a first reconstructed imaged and a second reconstructed image are respectively generated for the raw scan data and the modified raw scan data. The method 100 also includes extracting information form the reconstructed data (i.e., the first reconstructed image and the second reconstructed image) (block 104). In certain embodiments, the information extracted from the first reconstructed image and the second reconstructed image includes image derived values and reconstruction derived values. In certain embodiments, the image derived values include one or more of background activity mean and standard deviation, background activity max, feature activity mean, and feature activity max. In certain embodiments, the reconstruction derived values include one or more of beta map and kappa map. The method 100 further includes performing fitting and establishing a conversion model between the information extracted from the first reconstructed image and the second reconstructed image and the one or more target lesion values (block 106). In certain embodiments, the one or more target lesion values include actual activity value, actual feature size, or both.

FIG. 10 is a flow diagram of a method 100 for generating a result utilizing the system model. One or more steps of the method 100 may be performed by processing circuitry of an imaging system (e.g., PET imaging system 10 in FIG. 1) or a remote computing device. One or more of the steps of the method 100 may be performed simultaneously or in a different order from the order depicted in FIG. 10.

The method 100 includes defining (e.g., selecting) within the first reconstructed image (of the original raw scan data) a location with a clinical feature (block 110). In certain embodiments, multiple locations with respective clinical features may be defined or selected. In certain embodiments, the defining of the location with the clinical feature may be done via an input from the user. In certain embodiments, the defining of the location with the clinical feature may be done automatically.

The method 100 also includes extracting data information associated with the selected clinical feature (block 112). In certain embodiments, the data information extracted from the first reconstructed image includes image derived values and reconstruction derived values. In certain embodiments, the image derived values include one or more of background activity mean and standard deviation, background activity max, feature activity mean, and feature activity max. In certain embodiments, the reconstruction derived values include one or more of beta map and kappa map.

The method 100 further includes utilizing the conversion model to estimate a respective actual (e.g., true) value for the one or more target lesion values for the selected clinical feature utilizing the conversion model to correct the raw scan data associated with the selected clinical feature (block 114). In certain embodiments, respective actual (e.g., true) values are estimated for each selected clinical feature.

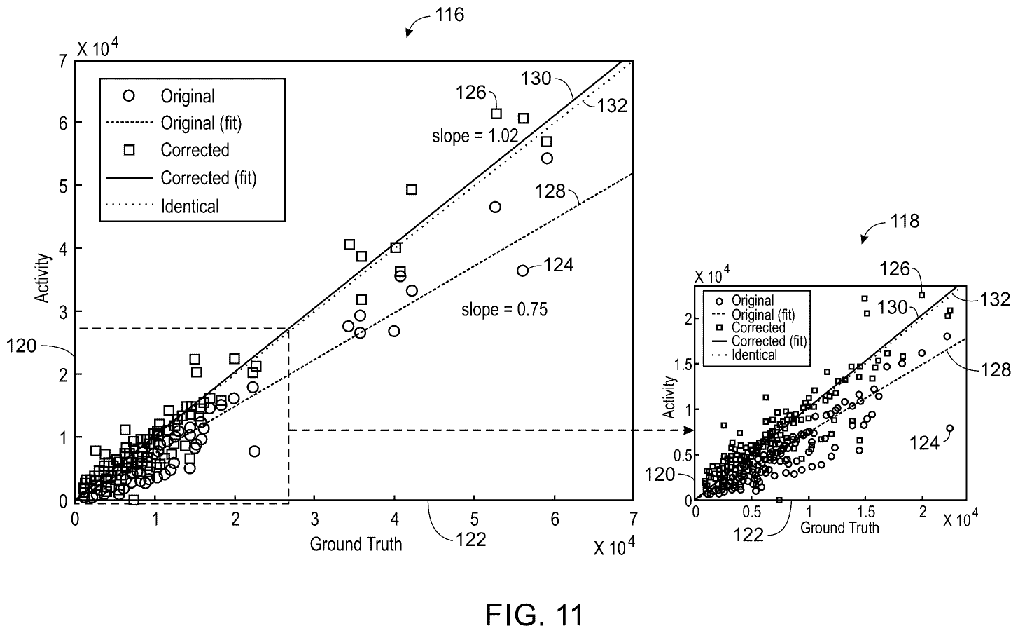

FIG. 11 is a graph 116 (e.g., scatter plot) and a zoomed portion 118 of the graph 116 illustrating a 10-fold cross-validation for original and corrected activities. In the 10-fold cross-validation, the true values of untrained data are utilized to evaluate the performance of the technique disclosed herein (e.g., data-driven system response correction as depicted in the method 70 in FIG. 7). In employing the correction technique, synthetic spheres (e.g., synthetic data) with known activity were inserted into patient data (e.g., original data).

A number of input features (e.g., information extracted from the reconstruction data) were utilized in employing the disclosed correction technique. The input features include inserted activity max, 3 centimeter (cm) sphere original mean, 3 cm sphere original max, 3 cm sphere original standard deviation, 3 cm inserted mean, 3 cm inserted maximum, 3 cm sphere inserted standard deviation, 75 percent threshold mean, 42 percent threshold mean, 25 percent threshold mean, 75 percent threshold volume of interest size, 42 percent volume of interest size, and 25 percent threshold volume of interest size.

The graph 116 includes a y-axis 120 representing activity for original values and estimated true values (e.g., obtained with the disclosed correction technique). The graph 116 includes an x-axis 122 representing ground truth activity. The circle points 124 are the original values versus the ground truth. The square points 126 are the estimated true values (e.g., utilizing the disclosed correction technique) versus the ground truth. Plot 128 is the fitted line for the circle points. Plot 130 is the fitted line for the square points. Plot 132 is a fitted line representing a hypothetical identical comparison. The respective slopes of the plots 128, 130 indicate that the corrected results (i.e., estimated true values) are significantly more accurate than original results when compared to the ground truth. Indeed, the plot 130 is very similar to plot 132.

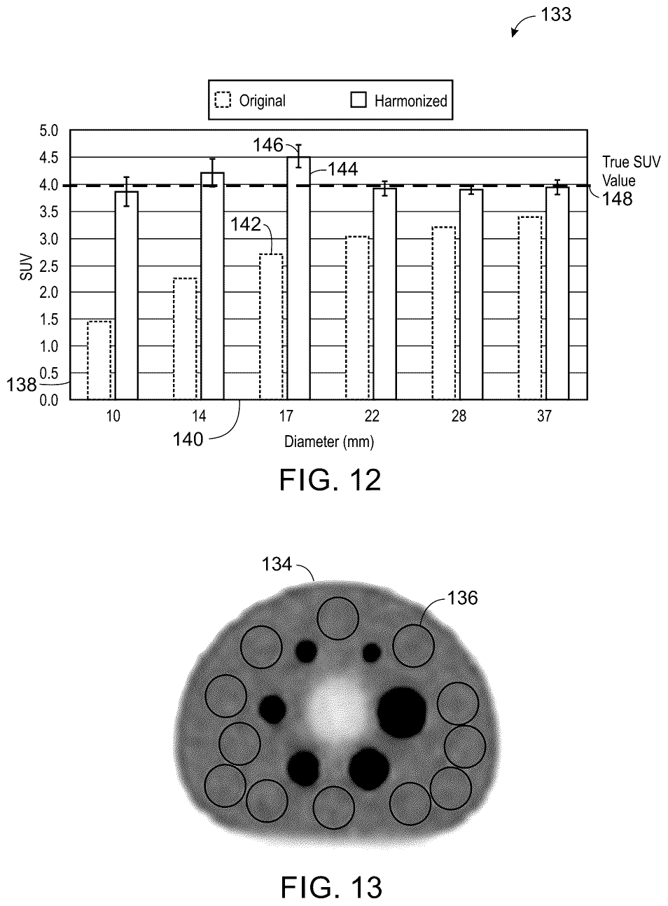

FIG. 12 is a graph 133 (e.g., bar graph) illustrating a comparison of original and corrected standardized uptake values (e.g., on data acquired from a phantom) relative to the true standardized uptake value. In particular, the original data is obtained from a National Electrical Manufacturers Association image quality phantom. In employing the correction technique, synthetic spheres (e.g., synthetic data) of different sizes were inserted into the original data acquired from the phantom. The synthetic spheres all have the same known standardized uptake value (e.g., true standardized uptake value). FIG. 13 depicts a PET image 134 of the phantom with circles 136 representing locations where the different sized spheres are inserted into the original data.

The graph 133 includes a y-axis 138 representing standardized uptake value. The graph 133 includes an x-axis 140 representing diameter in millimeters (mm). Bars 142 represent standard uptake values of the original data. Bars 144 represent standard uptake values of the corrected (e.g., harmonized) of the corrected (e.g., harmonized) data corrected with the disclosed correction technique. As depicted in the graph 133, the bars 144 have error bars 146. Dashed line 148 represents the true standardized uptake value. As depicted in the graph 133, the corrected (harmonized) results show better accuracy for different sized spheres than the original data compared to the true standardized uptake value.

Technical effects of the disclosed embodiments include providing systems and methods for data-driven system response correction. Technical effects of the disclosed embodiments include enabling accessing system responses by inserting known data into original data and then using an estimated system response to perform data correction. Technical effects of the disclosed embodiments include recovering a true (i.e., actual or accurate) value (e.g., lesion value) based on the data-driven system responses. In this case, results from different conditions (e.g., data collected by different scanners and/or processing techniques) can be comparable as the true value is revealed after the correction. Technical effects of the disclosed embodiments include improving quantification accuracy.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for accessing and correcting system responses, comprising:
obtaining, at a processor, raw scan data from a clinical scan of a subject with a medical imaging system;
inserting, via the processor, synthetic raw scan data with one or more known lesion values into the raw scan data to generate modified raw scan data;
separately reconstructing, via the processor, the raw scan data and the modified raw scan data to respectively generate a first reconstructed image and a second reconstructed image;
extracting, via the processor, information from the first reconstructed image and the second reconstructed image;
determining, via the processor, a system response to the inserted synthetic raw data based on the information extracted from the first reconstructed image and the second reconstructed image and one or more target lesion values, and wherein the system response is specific to the medical imaging system and a reconstruction technique utilized by the medical imaging system; and
utilizing, via the processor, the system response to correct the raw scan data.

2. The computer-implemented method of claim 1, wherein the synthetic raw scan data is derived from the raw scan data.

3. The computer-implemented method of claim 2, further comprising:
generating, via the processor, images with synthetic lesions based on the raw scan data;
performing, via the processor, forward projection on the images to generate the synthetic raw scan data;
applying, via the processor, corrections on the synthetic raw scan data; and
performing, via the processor, Poisson noise realization on the synthetic raw scan data to add noise to the synthetic raw scan data prior to insertion into the raw scan data.

4. The computer-implemented method of claim 1, further comprising receiving, at the processor, input of the one or more target lesion values.

5. The computer-implemented method of claim 1, wherein determining the system response comprises performing fitting and establishing a conversion model between the information extracted from the first reconstructed image and the second reconstructed image and the one or more target lesion values.

6. The computer-implemented method of claim 5, further comprising:
defining, via the processor, within the first reconstructed image a location with a clinical feature; and
extracting, via the processor, data information associated with the clinical feature; and
estimating, via the processor, a respective actual value for the one or more target lesion values for the clinical feature utilizing the conversion model to correct the raw scan data associated with the clinical feature.

7. The computer-implemented method of claim 6, wherein the medical imaging system comprises a positron emission tomography imaging system and the one or more target lesion values comprise standardized uptake value.

8. The computer-implemented method of claim 5, wherein the one or more target lesion values comprise actual activity value, actual feature size, or both.

9. The computer-implemented method of claim 5, wherein the information extracted from the first reconstructed image and the second reconstructed image comprises image derived values and reconstruction derived values.

10. The computer-implemented method of claim 9, wherein the image derived values comprise one or more of background activity mean and standard deviation, background activity max, feature activity mean, and feature activity max, and wherein the reconstruction derived values comprise one or more of a beta map and a kappa map.

11. A system for accessing and correcting system responses, comprising:
a memory encoding processor-executable routines;
a processing system comprising one or more processors and configured to access the memory and to execute the processor-executable routines, wherein the processor-executable routines, when executed by the processing system, cause the processing system to:
obtain raw scan data from a clinical scan of a subject with a medical imaging system;
insert synthetic raw scan data with one or more known lesion values into the raw scan data to generate modified raw scan data;
separately reconstruct the raw scan data and the modified raw scan data to respectively generate a first reconstructed image and a second reconstructed image;
extract information from the first reconstructed image and the second reconstructed image;
determine a system response to the inserted synthetic raw data based on the information extracted the first reconstructed image and the second reconstructed image and one or more target lesion values, and wherein the system response is specific to the medical imaging system and a reconstruction technique utilized by the medical imaging system; and
utilize the system response to correct the raw scan data.

12. The system of claim 11, wherein the synthetic raw scan data is derived from the raw scan data.

13. The system of claim 12, wherein the processor-executable routines, when executed by the processing system, further cause the processing system to:
generate images with synthetic lesions based on the raw scan data;
perform forward projection on the images to generate the synthetic raw scan data;
apply corrections on the synthetic raw scan data; and
perform Poisson noise realization on the synthetic raw scan data to add noise to the synthetic raw scan data prior to insertion into the raw scan data.

14. The system of claim 11, wherein determining the system response comprises performing fitting and establishing a conversion model between the information extracted from the first reconstructed image and the second reconstructed image and the one or more target lesion values.

15. The system of claim 14, wherein the processor-executable routines, when executed by the processing system, further cause the processing system to:
define within the first reconstructed image a location with a clinical feature; and
extract data information associated with the clinical feature; and
estimate a respective actual value for the one or more target lesion values for the clinical feature utilizing the conversion model to correct the raw scan data associated with the clinical feature.

16. The system of claim 15, wherein the medical imaging system comprises a positron emission tomography imaging system and the one or more target lesion values comprise standardized uptake value.

17. The system of claim 14, wherein the one or more target lesion values comprise actual activity value, actual feature size, or both.

18. The system of claim 14, wherein the information extracted from the first reconstructed image and the second reconstructed image comprises image derived values and reconstruction derived values.

19. A non-transitory computer-readable medium, the computer-readable medium comprising processor-executable code that when executed by a processing system comprising one or more processors, causes the processing system to:
obtain raw scan data from a clinical scan of a subject with a medical imaging system;
insert synthetic raw scan data with one or more known lesion values into the raw scan data to generate modified raw scan data;
separately reconstruct the raw scan data and the modified raw scan data to respectively generate a first reconstructed image and a second reconstructed image;
extract information from the first reconstructed image and the second reconstructed image;
determine a system response to the inserted synthetic raw data based on the information extracted from the first reconstructed image and the second reconstructed image and one or more target lesion values, and wherein the system response is specific to the medical imaging system and a reconstruction technique utilized by the medical imaging system; and
utilize the system response to correct the raw scan data.

20. The non-transitory computer-readable medium of claim 19, wherein determining the system response comprises performing fitting and establishing a conversion model between the information extracted from the first reconstructed image and the second reconstructed image and the one or more target lesion values and wherein the processor-executable code, when executed by the processing system, further causes the processing system to:
define within the first reconstructed image a location with a clinical feature; and
extract data information associated with the clinical feature; and
estimate a respective actual value for the one or more target lesion values for the clinical feature utilizing the conversion model to correct the raw scan data associated with the clinical feature.
